(19) United States
(12) Patent Application Publication
(10) Pub. No.: US 2019/0090316 A1
(43) Pub. Date: Mar. 21, 2019

(54) Code Arrangement and Package of System for Cooking a Foodstuff

(71) Applicant: NESTEC S.A., Vevey (CH)

(72) Inventors: Alexandre PERENTES, Sullens (CH); Praveen Kumar VADI, Aurora, OH (US)

(21) Appl. No.: 16/093,830

(22) PCT Filed: May 22, 2017
(86) PCT No.: PCT/EP2017/062202

§ 371 Date: Oct. 15, 2018

(30) Foreign Application Priority Data
May 24, 2016 (EP) 16171096.7

(51) Int. Cl. H05B 6/64; H05B 1/02

(52) U.S. Cl. CPC H05B 6/6441; H05B 6/6464; H05B 1/0263; H05B 6/6458; H05B 6/645

(57) ABSTRACT

The invention relates to a package (10) of a foodstuff cooking device, the package (10) for containing foodstuff and comprising on a surface thereof an arrangement of separate codes encoding cooking information, each code encoding a distinct phase of a cooking process, the phases in the cooking process being determined considering the deviation of the real value of at least one parameter significantly influencing the preparation of the foodstuff, with respect to a reference value of it. The at least one parameter measured is one or a combination of the following: weight of the foodstuff; weight of one or several ingredients in the foodstuff; geometrical distribution of one or several ingredients in the foodstuff; foodstuff initial temperature; foodstuff age; foodstuff uniformity; proportion and/or shape dimension of one or several ingredients in the foodstuff.

The invention further relates to a foodstuff cooking system (100) comprising a package (10) as the one described and a cooking device (20). The invention further relates to a method of cooking a foodstuff using such system (100).

### CROSS-REFERENCE TO RELATED APPLICATIONS/INCORPORATION BY REFERENCE STATEMENT

This application is a US national stage application filed under 35 USC § 371 of International Application No. PCT/EP2017/062202, filed May 22, 2017; which claims priority to EP App No. 16171096.7, filed May 24, 2016. The entire contents of the above-referenced patent applications are hereby expressly incorporated herein by reference.

### TECHNICAL FIELD

The present disclosure relates to a system for cooking a foodstuff, the system comprising a cooking device and a package comprising a foodstuff material. More particularly the present disclosure relates to a code arranged on the package that encodes preparation information and to a method of processing to decode said information.

### BACKGROUND

Increasingly cooking devices (such as ovens or microwaves) for the cooking of a foodstuff are configured to operate with a package or some kind of container comprising a foodstuff in its inner volume: at present, in order to enhance user convenience compared to conventional cooking devices, these packages are provided with a code either comprising certain cooking parameters or a certain encoding referring to a cooking recipe stored in the device in order to apply an appropriate cooking process to the foodstuff.

It is known in the state of the art, for example from document EP 1971189, a cooking oven, particularly a microwave oven, detecting food data and adjusting the food heating and/or the cooking process by means of a user interface. However, this system works with pre-stored recipes to be applied to the foodstuff, which makes that the process is not always optimal, and it also requires interaction from the user.

Document EP 1742513 discloses, for example, a cooking apparatus, cooking system and cooking control method using a bar code. The cooking apparatus for cooking food using cooking data includes a memory for storing identification data and cooking data of the food; an image capture device for obtaining an image of the food; and a controller for identifying the food by comparing the image of the food to the identification data of the food, stored in the memory, obtaining the cooking data of the identified food, and controlling the cooking apparatus so that the cooking of the food is performed based on the cooking data. This system therefore uses pre-stored data on recipes on how to process the foodstuff in the cooking apparatus, which is not always optimal.

Another example is provided by document EP 1732358, disclosing an apparatus and a method for controlling a microwave oven using a bar code. The apparatus includes an operating panel on the microwave oven, a bar code scanner in the operating panel and projecting light to the bar code attached to a package of food to obtain data of the bar code, and a main controller for controlling a cooking operation for cooking the food according to the data of the bar code obtained by the bar code scanner. The apparatus performs the cooking of food using the bar code, according to certain recipes stored. However, as already disclosed, cooking is not always optimally done.

When cooking is intended to be done in a very optimal way, it should therefore be needed that the code in the package or container provides a certain number of parameters comprising cooking information on the cooking process to be applied. This would require to encode large amounts of information as preparation processes increase in complexity due to the development of more sophisticated machines, which are able to prepare a wide-range of foodstuff.

However, even when a large number of data and cooking information is comprised in the code, the meals produced in the same device vary depending on the starting parameters of the foodstuff comprised in the package or container. For example, when it comes to frozen meals, the final meals cooked in a same device or oven under the same cooking parameters are not the same, as the departing data of the frozen foodstuff varies, typically for example a weight variation has been detected when a foodstuff is produced industrially. When looking even closer, there is even a variation on all the different ingredients in a meal or foodstuff in a package or container. For example, when several trials have been run on the same departing product, even when applying the same cooking or process parameters, results vary in a high extent. Moreover, the variation range is so large that it becomes significant for the consumer, appreciating that the final product has not been optimally processed by the system.

Therefore, there exists the need of providing a code arrangement on a container or package of foodstuff, this code further comprising information on one or several departing parameters, such as for example weight, in order to properly adjust the cooking parameters applied and optimise the cooking process.

### BRIEF DESCRIPTION OF THE DRAWINGS

For a better understanding of the present disclosure, and to show how embodiments of the same may be carried into effect, reference will now be made, by way of example, to the accompanying diagrammatic drawings in which:

FIGS. 1-2 are illustrative views of an embodiment of a cooking system according to the present disclosure comprising a cooking device and a package containing foodstuff.

FIG. 3 is block diagram of a control system for the cooking device of FIG. 1 or 2.

FIGS. 4A-B show embodiment code arrangements for packages for the cooking system of FIGS. 1-2.

FIGS. 5-8E show embodiment codes for packages for the cooking system of FIGS. 1-2.

FIG. 9 shows one possible embodiment of a cooking system according to the present disclosure, as shown in FIGS. 1-2, where the code processing system is arranged in the cooking device.

FIG. 10 shows another possible embodiment of a cooking system according to the present disclosure, as shown in FIGS. 1-2, where the code processing system is arranged outside the cooking device.

### DETAILED DESCRIPTION

According to a first non-limiting aspect, the present disclosure relates to a package of a foodstuff cooking device, the package for containing foodstuff and comprising on a surface thereof an arrangement of separate codes encoding foodstuff information related to a preparation process for cooking the foodstuff, at least one code encoding information on at least one foodstuff parameter significantly influencing the preparation of the foodstuff, which considers the deviation of the real value of this at least one parameter with respect to a reference value of it.

In certain non-limiting embodiments, the at least one parameter measured is one or a combination of the following: weight of the foodstuff; weight of one or several ingredients in the foodstuff; geometrical distribution of one or several ingredients in the foodstuff; foodstuff initial temperature; foodstuff age; foodstuff uniformity; proportion and/or shape dimension of one or several ingredients in the foodstuff.

Typically, the codes further comprise foodstuff information, such as brand and/or foodstuff group and/or foodstuff type. This foodstuff information can be used to stablish the reference value of the at least one parameter significantly influencing the preparation of the foodstuff.

In certain non-limiting embodiments, the phases in the cooking process comprise values of one or a plurality of the following parameters:
type of cooking means used in the cooking device;
sequence of phases and respective parameters;
application time of each of the cooking means used;
power of each of the cooking means used;
geometrical application of each of the heating means used;
cooling means used;
time of application of cooling means.

In certain non-limiting embodiments, the arrangement of separate codes further comprises a dynamic code providing information on at least one parameter varying in time. The dynamic code typically provides information of the instant foodstuff temperature and, in certain non-limiting embodiments, uses thermochromic ink.

According to the present disclosure, the passage from the distinct phases is, in certain non-limiting embodiments, triggered by the phase duration and/or by the instant foodstuff temperature and/or by the foodstuff moisture content and/or by the foodstuff colour and/or by the foodstuff absorption at specific wavelengths.

Typically, the codes are arranged as a plurality of columns, the columns being adjacent each other and extending along parallel tracks, adjacent columns being offset with respect to each other in a direction along said tracks.

Also, the codes can also be arranged in a sequence that is ordered according to an order of use of the phases encoded therein during a cooking process. Typically, the codes are arranged into a plurality of coding regions, each coding region comprising:
a plurality of codes encoding the same phase, the regions having said sequential arrangement; or
a plurality of codes encoding the different phases, said plurality of codes in each region having said sequential arrangement.

In the package of the present disclosure, typically one or more of the codes encodes as the cooking information a phase identifier to identify an order of the phase used during said preparation process.

According to the present disclosure, the code can typically comprise a reference portion and a data portion:
the reference portion comprising a linear arrangement of at least two reference units defining a reference line r;
the data portion comprising at least one data unit, said data unit being arranged on an encoding line D that intersects the reference line r, the data unit occupies a distance d along the encoding line D as a variable to at least partially encode a parameter of the cooking information.

In certain non-limiting embodiments, the encoding line D has one of the following arrangements:
the encoding line D is circular and is arranged with a tangent thereto orthogonal to the reference line rat said intersection point;
the encoding line D is linear and arranged orthogonal to the reference line r.

According to the present disclosure, the said arrangement of codes are, in certain non-limiting embodiments, formed on a surface of the package or on an attachment, which is attached thereto.

According to a second non-limiting aspect, the present disclosure relates to a foodstuff cooking system comprising a package as described and a cooking device, comprising:
a code processing system operable to: obtain one or more digital image(s) of a plurality of codes of the package; process said digital image(s) to decode for each phase of a cooking process the encoded preparation information and to determine an order of said phases;
a control system operable to control the cooking device to execute the preparation process using said decoded preparation information in the determined order of phases.

Typically, the code processing system in the foodstuff cooking system according to the present disclosure can be arranged in the cooking device and/or in the system and/or externally arranged.

According to still a third non-limiting aspect, the present disclosure further relates to a method of cooking a foodstuff using the described system, the method comprising:
obtaining one or more digital images of a plurality of codes of the container;
processing said digital image(s) to decode for each phase of a beverage preparation process the encoded preparation information and to determine an order of said phases;
a control system operable to control the preparation unit to execute the preparation process using said decoded preparation information in the determined order of phases.

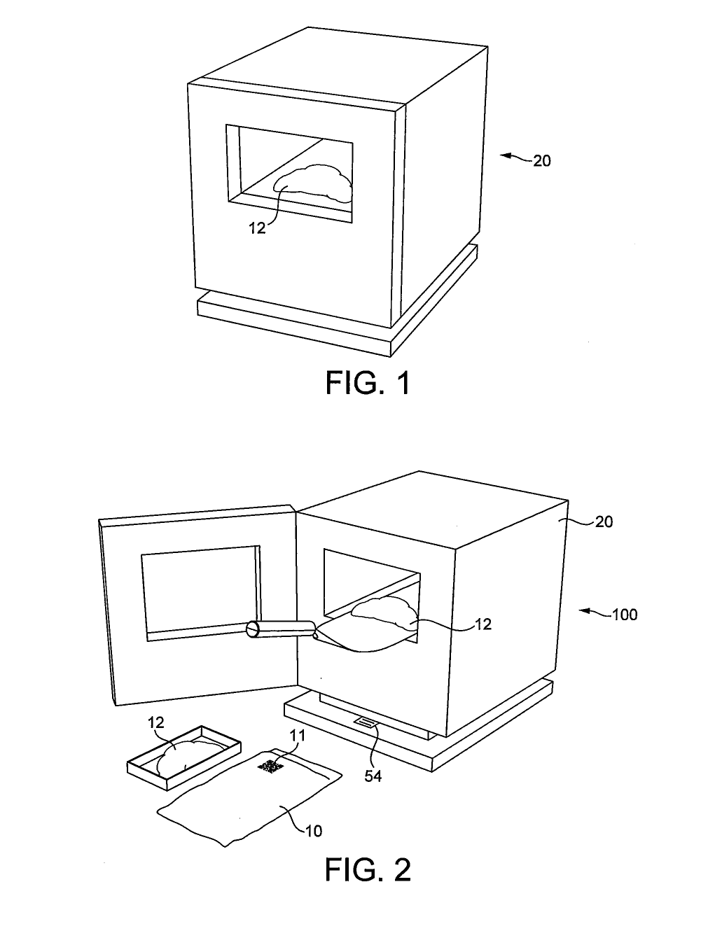

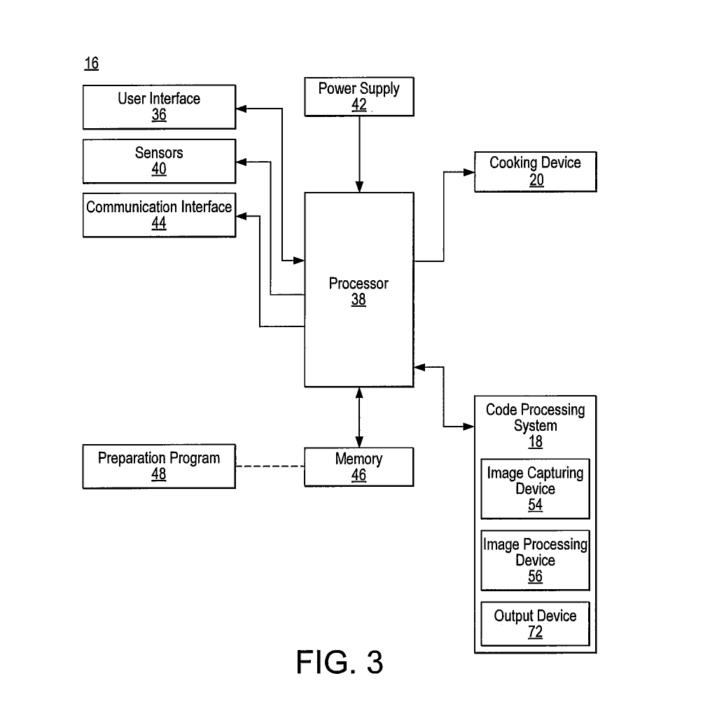

The present disclosure presents a cooking system 100 for cooking a foodstuff as exemplified in FIG. 1 or 2: the cooking system 100 comprises a cooking device 20 and a package 10, the package comprising a foodstuff material in its inner volume. The package comprises identification means 11 (typically a code) with information leading to the preparation process to be applied by the cooking device 20.

Typically, the cooking device 20 is an oven or a microwave oven which is able to process the foodstuff content of the package 10. In many cases, the foodstuff in the package 10 is a frozen product, which is taken out from the package before it is processed in the device 20: the device then applies a cooking procedure depending on the product to be cooked and further on certain parameters as it will be further explained. Both the type of product and the parameters are comprised in the identification means 11, typically arranged in the package 10.

Typically when the product is being manufactured, there are certain parameters which can deviate from standard production, such as for example the actual weight of the product, or the actual weight of the ingredients in it. Some other parameters which can vary are for example the geometrical distribution of one or more of the ingredients in the foodstuff, the foodstuff initial temperature, the foodstuff age, the foodstuff uniformity, or for example the proportion and/or the shape dimension of one or several ingredients in the foodstuff. When a standard cooking process is applied to this product, final results will deviate from expected, and the product will not be optimal. Therefore, the codification in the identification means 11 of the product needs to take into consideration the real parameters in production or their deviation with respect to standard ones. In the production line, at least one parameter (for example, the weight of the product and/or of its ingredients and/or of other parameters as exemplified before) is measured and specific cooking process parameters are printed or included in the identification means 11; therefore, indication of correct cooking process parameters is given to the device when the product is processed. Thus, specific cooking parameters will be applied depending on the real product to cook, so optimal cooking will be delivered and the consumer will be ensured with same guaranteed quality at the end.

Typically, the identification means 11 will comprise two types of parameters, so called product parameters and real parameters. The product parameters will comprise the type of product that is going to be cooked in the device (product identification, such as brand and/or product group and/or product type), for example frozen pizza, lasagne, spinach lasagne, a certain or several types of vegetables, and also the size of the product, family size, individual portion, etc. indicating the device what kind of product is going to be cooked. Typically, these product parameters are used to stablish the reference value of at least one parameter significantly influencing the preparation of the foodstuff (such as weight, for example). Further, the identification means 11 will comprise real parameters, comprising values of process parameters to be applied by the device 20, such as frequency (microwave heating), cooking time, hot air temperature, power of infrared, etc. which take into consideration the real manufacturing process carried out when the product is produced. Typically, by knowing the real weight and/or the real ingredients weight in the manufacturing line (and/or other parameters), real cooking parameters are printed in the identification means 11. Further, the positioning of the ingredients in the product when they are manufactured can be also taken into consideration in the manufacturing line, so real positioning process parameters can also be comprised in the identification means 11.

Other real parameters measured in the production line can be taken into consideration for printing specific process parameters in the identification means 11 in the package 10 comprising the foodstuff, for example dimension or size variation of the products, real positioning of ingredients, etc.

When it comes to using the system of the present disclosure with foodstuff originally frozen when introduced in the device, the identification means can further be provided with at least one dynamic parameter, such as the departing temperature of the product when being introduced in the device. For this, the identification means will be further provided with encoded information made using for example temperature sensitive ink varying depending on real temperature dynamically measured with time, which therefore indicates the device the real temperature of the foodstuff at the moment in time when the product is being cooked. For example, several dots are made with temperature sensitive ink: some of them start disappearing when the temperature raises for example, so the remaining dots indicate the device the real temperature of the foodstuff to cook, so cooking parameters are consequently adapted.

For achieving this, a thermochromatic ink is typically used to make this dynamic parameter encoding. This thermochromatic ink changes colour with heat, so the code can vary depending on the temperature of the package where it is typically arranged. By this, the cooking device 20 is provided with the information on the real departing temperature of the foodstuff in the package 10 when it is going to be cooked, so the cooking parameters are consequently adapted. In certain non-limiting embodiments, a reversible thermochromatic ink will be used, allowing the colour to revert when the temperature returns to its original level.

The cooking system according to the present disclosure further comprises a control system 16 and a code processing system 18, similar to those described in patent application EP 15165920.8, belonging to the same applicant and incorporated by reference, herewith.

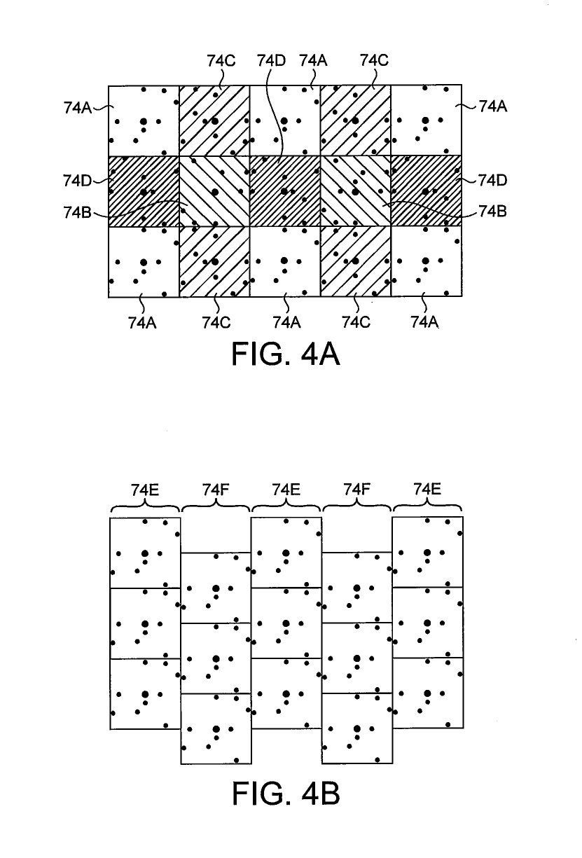

The control system 16, an example of which is illustrated in FIG. 3, is operable to control the cooking device 20 to prepare the foodstuff. The control system 16 typically comprises: a user interface 36; a processor 38; optional sensors 40; a power supply 42; an optional communication interface 44; all of these having been described in EP 15165920.8.

Typically, the package 10 comprises an external package and inside a foodstuff which can optionally be frozen. The package 10 may be formed from various materials, such as metal or plastic or a combination thereof. In general, the material is selected such that it is food-safe and can withstand the cooking temperatures. As discussed, the identification means 11 are, in certain non-limiting embodiments, arranged in the external package and are read by the code processing system 18, which obtains an image of the code on the package 10 and processes said image to decode the encoded preparation (cooking) information. As shown in FIG. 3, the code processing system 18 comprises an image capturing device 54, an image processing device 56 and an output device 72.

The package 10 comprises an arrangement of a plurality of codes 74, whereby each code encodes a phase, i.e. a distinct portion, of a cooking or preparation operation, there may for example be 3-10 sequential phases that the preparation or cooking operation is composed of. Typically each code 74 encodes a phase that comprises preparation information, which generally comprises information related to the associated cooking process.

Depending on the embodiment of the cooking device 10, said information may encode one or more parameters, which may comprise one or more of (all these parameters already taking into consideration the real data of the foodstuff product such as weight, for example, when the product is manufactured):
type of cooking or heating means or combination thereof to be used (microwave, infrared, hot air, etc.)
sequence of the cooking phases and respective parameters
time of application of each of the cooking or heating means used
frequency of microwave heating means
temperature of hot air heating means
power of infrared heating means
positioning or geometrical application of each of the heating means used
cooling means used
time of application of cooling means
temperature of cooling air used
temperature of the product at the end of the process
phase identifier, e.g. an alphanumeric identifier, to identify the sequence which of a plurality of phases the aforesaid one or more parameters relate
etc.

More particularly, the code may encode trigger parameters, whereby if a particular condition associated with the trigger parameters is met the associated phase of the cooking process is complete, and the next phase can be executed. Typically the trigger parameters are: phase duration, instant foodstuff temperature, foodstuff moisture content, foodstuff colour foodstuff absorption at specific wavelengths, etc. Typically the said condition comprises, for at least one of the trigger parameters, measured parameter corresponding to a value encoded by a trigger parameter.

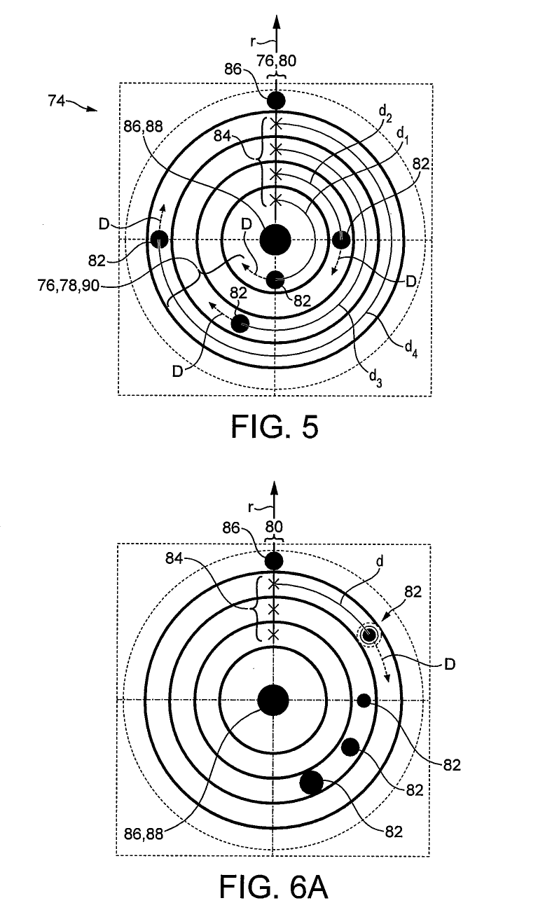

The codes 74 are arranged on an exterior surface of the package 10 in any suitable position such that they can be processed by the code processing system 18. The codes 74 generally have a periphery that is repeatable with a tessellating arrangement. An example of such an arrangement is a right-angled parallelogram shape (i.e. a square or rectangle). In this way the codes can be compactly arranged together. For the following first embodiment code 74 that has a circular encoding area, the encoding area is arranged within a square periphery to achieve such a shape. The codes may be arranged adjacent to each other on at least one edge, i.e. they extend along a line which is at least one code wide. The codes may all have the same orientation. Alternatively, the adjacent codes may be rotated by one of 90°, 180°, 270°, an example of such an arrangement is shown in FIG. 4A, wherein 74A, 74B, 74C, 74D designates the respective rotation. Advantageously by having a more variable arrangement the coding on a container is less visible.

The codes are generally arranged along a line, herein termed a column, i.e. in a 1×i arrangement wherein i extends along the line. The line may be linear or non-linear, such as circumferentially extending. In certain non-limiting embodiments, there are a plurality of columns arranged adjacent each other and extending longitudinally along parallel said line, i.e. track arrangements. In FIG. 4A the arrangement may be considered to comprise 5 columns, each with a 1×3 arrangement. The columns may be aligned with each other (as illustrated in FIG. 4A) such that the rows, which extend perpendicular to the columns, are aligned. With such an arrangement a vertex of a code is common to four codes. Alternatively adjacent columns may be offset with respect to each other along said lines such that the rows are not aligned (an example of such an arrangement is illustrated in FIG. 4B, whereby adjacent columns are 74E, 74F). With such an arrangement a vertex of a code is common to two codes only. Advantageously by having a more variable arrangement coding is less visible.

The codes are generally arranged in a particular sequence according to the phase encoded, whereby said phases are arranged in an order according to use during the preparation process (e.g. the phases are arranged numerically along a column in order from 1-n, whereby phase 1 is used first, followed by 2 and so up to n). The order may also correspond to a reading direction in an example wherein the image capturing device 54 moves or has a focal position that moves relative the codes 74 as part of an image capturing process. Advantageously the location of the codes can be processed to determine conveniently the order of the phases encoded therein.

Generally the codes 74 are arranged into a plurality of coding regions, such as (but not limited to) 2-6 regions. Each coding region may comprise a plurality of codes with each code encoding the same phase (i.e. identical codes), whereby the coding regions have the aforesaid sequential arrangement (i.e. the coding regions are arranged in an order according to use of the phase encoded therein during the preparation process). Alternatively, each coding region may comprise a plurality of codes with the codes encoding the range of phases, whereby said plurality of codes in each coding region has the aforesaid sequential arrangement (i.e. the codes in the coding regions are arranged in an order according to the use of the phase during the preparation process). Examples both arrangements are described following.

As an alternative (or in addition) to having the aforesaid further coding regions one or more of the codes (such as (but not limited to) all) may encode as the preparation information (or in addition thereto) a phase identifier to identify an order of the phase used during said preparation process. The phase identifier can be processed by the code processing system 18 to determine an associated phase number/order. In certain non-limiting embodiments the phase identifier is numeric or alphanumeric and is encoded discretely, i.e. it can assume one or a plurality of predetermined values. In the following particular (but non-limiting) example codes 74 the phase identifier may be encoded as a particular distance d for a particular parameter. With an encoded phase identifier it will be appreciated that it possible to have an arbitrary arrangement of codes, i.e. as opposed to an organised arrangement such as those of the first and second embodiments. Advantageously the visibility of the codes 74 can be reduced.

The code 74 is configured to encode the preparation information in a manner for capturing by the image capturing device 54. More particularly, the code is formed of a plurality of micro-units 76 with a surround of a different colour: typically the units comprise a dark colour (e.g. one of the following: black, dark blue, purple, dark green) and the surround comprises a light colour (e.g. one of the following: white, light blue, yellow, light green) or the converse, such that there is sufficient contrast for the image processing device 56 to distinguish there between. The units 76 may have one or a combination of the following shapes: circular; triangular; polygon, in particular a quadrilateral such as square or parallelogram; other known suitable shape. It will be appreciated that due to formation error, e.g. printing error, the aforesaid shape can be an approximation of the actual shape. The units 76 typically have a unit length of 50-200 μm (e.g. 60, 80, 100, 120, 150 μm). The unit length is a suitably defined distance of the unit, e.g.: for a circular shape the diameter; for a square a side length; for a polygon a diameter or distance between opposing vertices; for a triangle a hypotenuse. In certain non-limiting embodiments, the units 76 are arranged with a precision of about 1 μm.

Typically the units 76 are formed by: printing e.g. my means of an ink printer; embossed; engraved; otherwise known means. As an example of printing the ink may be conventional printer ink and the substrate may be: polyethylene terephthalate (PET); aluminium coated with a lacquer or other suitable substrate. As an example of embossing the shape may be pressed into a plastically deformable substrate (such as the aforesaid aluminium coated with a lacquer) by a stamp.

The units 76 are organised into a: data portion 78 to encode the preparation information; reference portion 80 to provide a reference for the data portion 78. The reference portion 80 comprises a plurality of reference units 86, the centres of which have a linear arrangement to define a reference line r. One of the reference units 86 generally is a reference line r orientation identifier 88, which is identified to determine the orientation of said line. The data portion 78 may comprise an encoding area 90, within the bounds of which the data units 82 are arranged. A data unit 82 is arranged on an encoding line D that intersects the reference line r. Generally the data unit is able to occupy any continuous distance d along the data line D, as opposed to discrete positions only (i.e. discrete meaning predetermined positions only), as a variable to encode a parameter of the preparation information. In this respect a wider range of information may be encoded. The data portion 78 comprises n data units 82, wherein n is numerically 1 or more, and thus generally encodes n parameters. In a similar fashion the reference portion 80 comprises m reference units 86, wherein m is numerically at least two.

More particularly the encoding line D intersects the reference line r at a reference position 84. A reference position 84 may or may not comprise a reference unit 86. The distance d is defined from the reference position to a position on the encoding line D which a centre of the data unit 82 is arranged on, or arranged proximate thereto, e.g. at a position on the encoding line D which is intersected by a line through the centre of the data unit 82, whereby said line is orthogonal to the encoding line D at the point of intersection.

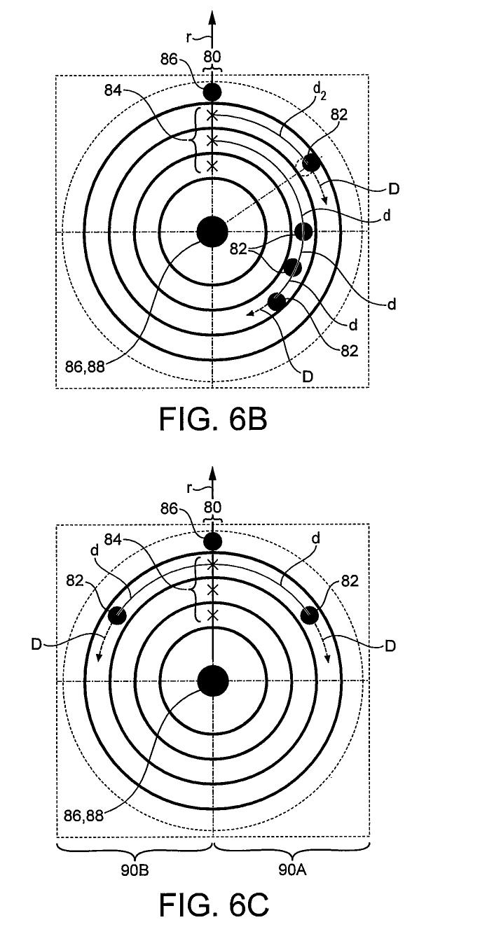

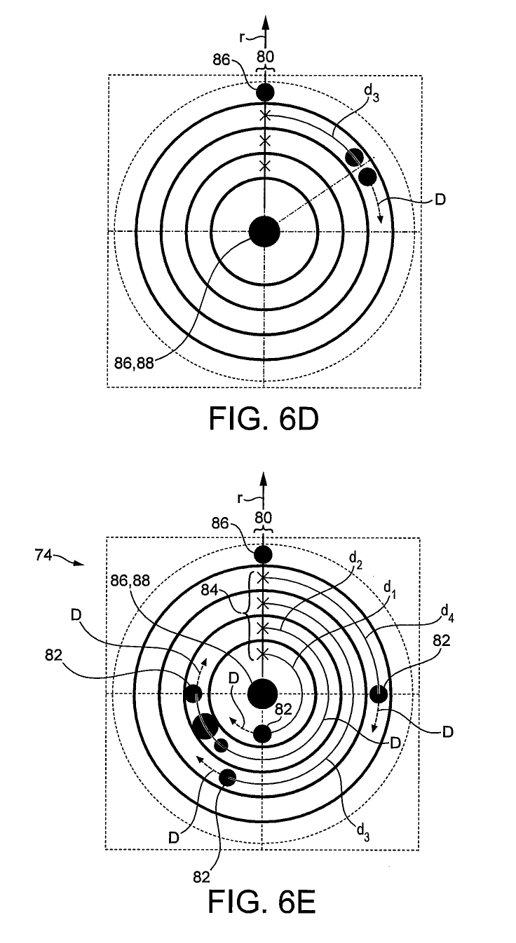

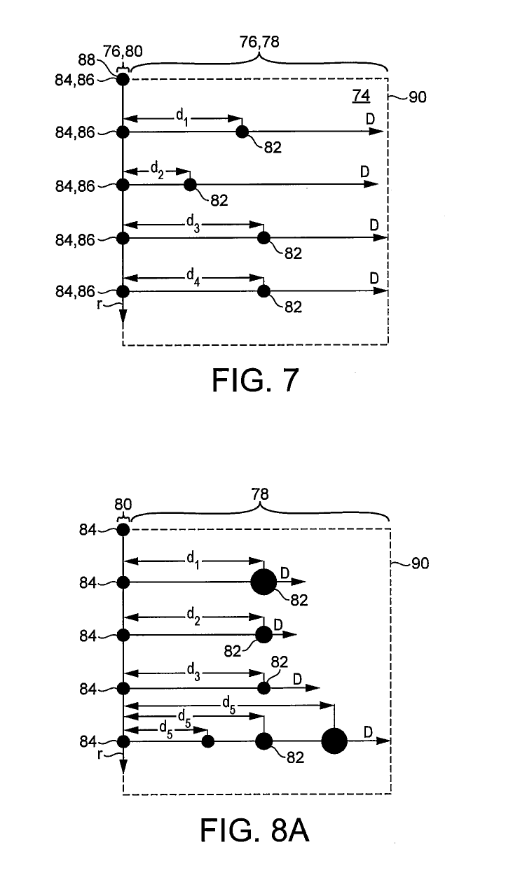

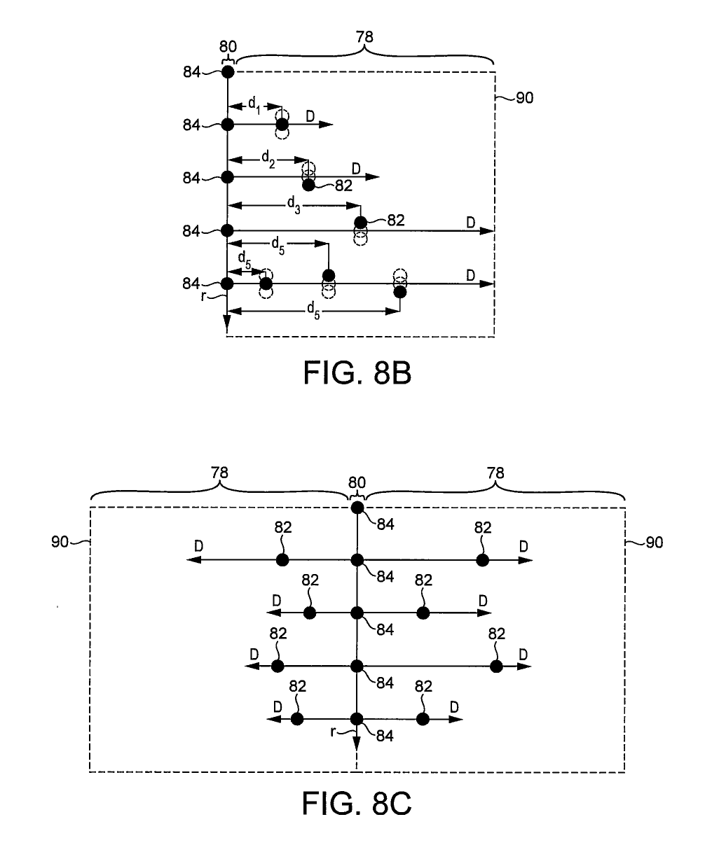

As described in EP 15165920.8, incorporated herewith by reference, the code according to the present disclosure can be a code with polar coordinate arrangement, as represented in FIGS. 5 and 6A-E, described in detail in the before mentioned patent application of the same applicant, or a code with Cartesian coordinate arrangement, as per attached FIGS. 7 and 8A-E, also detailed in EP 15165920.8.

According to another non-limiting aspect, the present disclosure also relates to a foodstuff cooking system 100 comprising a package 10 as the one previously described and a cooking device 20. The system 100 comprises:
a code processing system 18 operable to: obtain one or more digital image(s) of a plurality of codes of the package 10; process said digital image(s) to decode for each phase of a cooking process the encoded preparation information and to determine an order of said phases;
a control system 16 operable to control the cooking device 20 to execute the preparation process using said decoded preparation information in the determined order of phases.

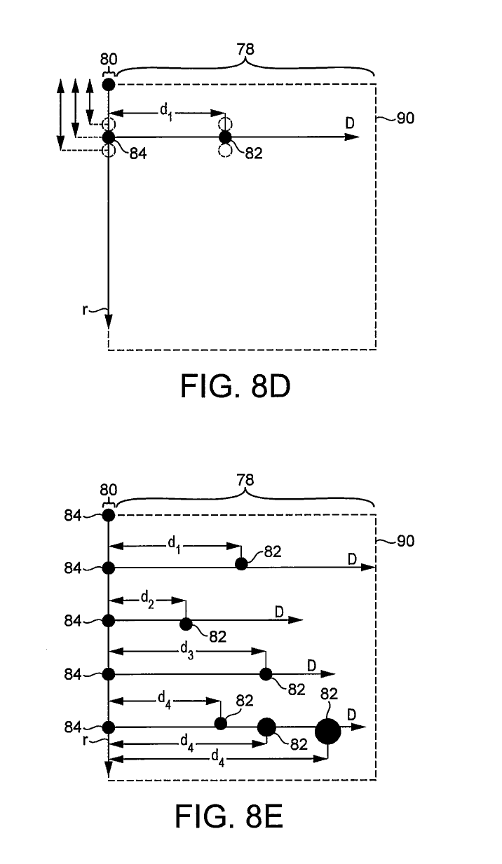

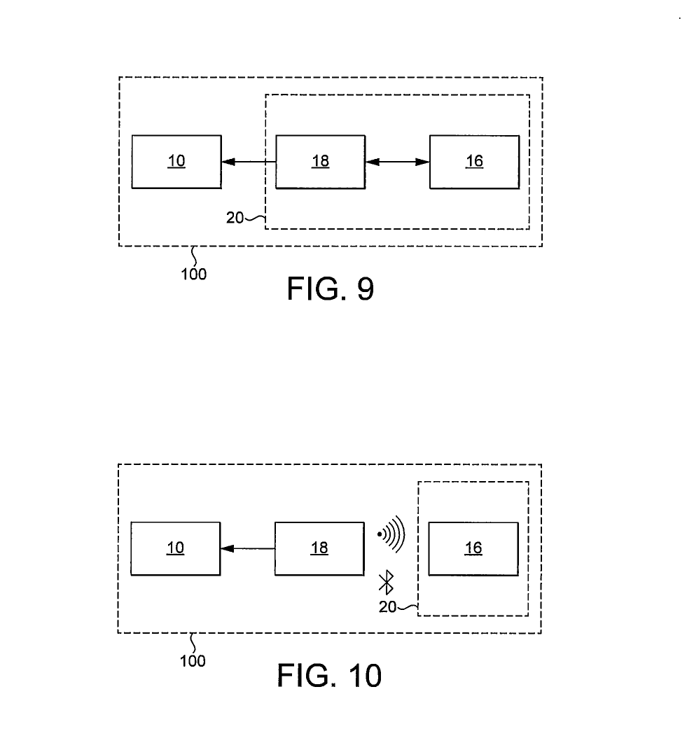

The code processing system 18 can be arranged in the cooking device 20, as shown for example in FIG. 9 or it can be arranged in the system 100 as shown in FIG. 10. FIG. 9 shows the code processing system 18 and the control system 16 arranged in the cooking device 20, meaning that the processing system 18 reads the information in the identification means 11 in the pack 10 when said pack is entered in the device 20: then this information is communicated to the control system 16, which operates the cooking device 20 according to certain cooking phases as comprised in the identification means 11. FIG. 10 shows another embodiment where the code processing system 18 is arranged outside the device 20, so then reads the information in the identification means 11 of the pack 10, and then communicates it to the control system 16 by Wi Fi, Bluetooth or the like, so the control system 16 tells the device 20 which cooking phases to apply. Another possibility (not shown) is that the code processing system 18 is arranged externally.

According to still another non-limiting aspect, the present disclosure also relates to a method of cooking a foodstuff using the system 100 as described previously, the method comprising:
obtaining one or more digital images of a plurality of codes of the container 10;
processing said digital image(s) to decode for each phase of a beverage preparation process the encoded preparation information and to determine an order of said phases;
a control system operable to control the preparation unit to execute the preparation process using said decoded preparation information in the determined order of phases.

According to yet another non-limiting aspect, the present disclosure further relates to a method of processing to decode the information comprised in the code or identification means in order to determine the cooking procedure applied by the cooking device 10. The method has been already described in EP 15165920.8.

The code processing system 18 processes individual codes according to the above examples to determine the cooking information by: obtaining by means of the image capturing device 54 a digital image of the code; processing by means of the image processing device 56 digital data of the digital image to decode the cooking information; outputting by means of the output device 72 said decoded cooking information.

Processing of the digital data comprises: locating the units 82, 86 in the code; identifying the reference units 86 and determining therefrom a reference line r; determining for each data unit 82 a distance d along the encoding line D from the reference line r, each of which has already been sequentially described in EP 15165920.8.

Although the present disclosure has been described with reference to particular embodiments thereof, many modifications and alternations may be made by a person having ordinary skill in the art without departing from the scope of the present disclosure which is defined by the appended claims.

1. A package of a foodstuff cooking device, the package for containing foodstuff and comprising on a surface thereof an arrangement of separate codes encoding cooking information, each code encoding a distinct phase of a cooking process, whereby the phases in the cooking process are determined considering the deviation of the real value of at least one parameter significantly influencing the preparation of the foodstuff, with respect to a reference value of it.

2. The package according to claim 1, wherein the at least one parameter measured is one or a combination of the following: weight of the foodstuff; weight of one or several ingredients in the foodstuff; geometrical distribution of one or several ingredients in the foodstuff; foodstuff initial temperature; foodstuff age; foodstuff uniformity;
proportion and/or shape dimension of one or several ingredients in the foodstuff.

3. The package according to claim 1 wherein the codes further comprise foodstuff information.

4. The package according to claim 3, wherein the foodstuff information is used to establish the reference value of the at least one parameter significantly influencing the preparation of the foodstuff.

5. The package according to claim 1, wherein the phases in the cooking process comprise values of one or a plurality of the following parameters:
type of cooking means used in the cooking device;
sequence of phases and respective parameters;
application time of each of the cooking means used;
power of each of the cooking means used;
geometrical application of each of the heating means used;
cooling means used; and
time of application of cooling means.

6. The package according to claim 1, wherein the arrangement of separate codes further comprises a dynamic code providing information on at least one parameter varying in time.

7. The package according to claim 6, wherein the dynamic code provides information of the instant foodstuff temperature.

8. The package according to claim 6, wherein the dynamic code uses thermochromic ink.

9. The package according to claim 1, wherein the passage from the distinct phases is triggered by the phase duration and/or by the instant foodstuff temperature and/or by the foodstuff moisture content and/or by the foodstuff colour and/or by the foodstuff absorption at specific wavelengths.

10. The package according to claim 1, wherein the codes are arranged as a plurality of columns, the columns being adjacent each other and extending along parallel tracks, whereby adjacent columns are offset with respect to each other in a direction along said tracks.

11. The package according to claim 1, wherein the codes are arranged in a sequence that is ordered according to an order of use of the phases encoded therein during a cooking process.

12. The package according to claim 11, wherein the codes are arranged into a plurality of coding regions, whereby each coding region comprises:
a plurality of codes encoding the same phase, whereby the regions have said sequential arrangement; or
a plurality of codes encoding the different phases, whereby said plurality of codes in each region have said sequential arrangement.

13. The package according to claim 1, wherein one or more of the codes encodes as the cooking information a phase identifier to identify an order of the phase used during said preparation process.

14. The package according to claim 1, wherein the code comprises a reference portion and a data portion:
the reference portion comprising a linear arrangement of at least two reference units defining a reference line r; and
the data portion comprising at least one data unit, wherein said data unit is arranged on an encoding line D that intersects the reference line r, the data unit occupies a distance d along the encoding line D as a variable to at least partially encode a parameter of the cooking information.

15. The package according to claim 14, wherein the encoding line D has one of the following arrangements:
the encoding line D is circular and is arranged with a tangent thereto orthogonal to the reference line r at said intersection point; or
the encoding line D is linear and arranged orthogonal to the reference line r.

16. The package according to claim 1, wherein the said arrangement of codes are formed on a surface of the package or on an attachment, which is attached thereto.

17. A foodstuff cooking system comprising a package according to claim 1 and a cooking device, comprising:
a code processing system operable to: obtain one or more digital image(s) of a plurality of codes of the package; process said digital image(s) to decode for each phase of a cooking process the encoded preparation information and to determine an order of said phases;
a control system operable to control the cooking device to execute the preparation process using said decoded preparation information in the determined order of phases.

8. The foodstuff cooking system according to claim 17, wherein the code processing system is arranged in the cooking device and/or in the system and/or is externally arranged.

19. A method of cooking a foodstuff using the system according to claim 17, the method comprising:
obtaining one or more digital images of a plurality of codes of the container;
processing said digital image(s) to decode for each phase of a beverage preparation process the encoded preparation information and to determine an order of said phases;
a control system operable to control the preparation unit to execute the preparation process using said decoded preparation information in the determined order of phases.
